(19) United States
(12) Patent Application Publication
(10) Pub. No.: US 2006/0092993 A1
(43) Pub. Date: May 4, 2006

(54) High-power mode-locked laser device

(75) Inventor: Robert Frankel, Rochester, NY (US)

Correspondence Address: FISH & NEAVE IP GROUP;ROPES & GRAY LLP, ONE INTERNATIONAL PLACE, BOSTON, MA, 02110-2624, US

(73) Assignee: Chromaplex, Inc., West Henrietta, NY (US)

(21) Appl. No.: 10/978,808

(22) Filed: Nov. 1, 2004

(51) Int. Cl. H01S 3/098; H01S 3/08

(52) U.S. Cl. 372/18; 372/102

(57) ABSTRACT

A mode-locked external cavity laser device includes a plurality of gain elements with corresponding end mirrors, and a diffracting element that diffracts optical beams emitted by the gain elements and combines the diffracted optical beams to form an overlapping output beam. A mode-locking device that intercepts the overlapping output beam and in cooperation with the end mirrors forms the external cavity. The mode-locking device mode-locks the optical beams from the gain elements in common and thus forms a mode-locked optical output beam of picosecond or femtosecond duration and high peak power.

### BACKGROUND OF THE INVENTION

The invention relates to a laser device, and more particularly to an external cavity laser device with a plurality of gain elements producing a combined output beam of picosecond or femtosecond pulses with high peak power.

Many applications require high-power lasers with a suitable pulse width and capable of a high repetition rate. In particular, there is an increasing need for high peak power and high average power picosecond and femtosecond lasers for many applications. These lasers are often used when it is required to take advantage of the non-linear interaction of high intensity optical pulses with matter. Non-linear interactions often occur when the focused optical field is raised to 10⁸-10¹⁶ W/cm² or more. In addition, when the pulse width of the laser is less than a few picoseconds, classical thermal transport effects are minimized. Non-linear optical effects include multi-photon absorption by molecules and non-thermal multi-photon induced surface ablation. Applications include quantum control of chemical reactions, High Harmonic Generation (HHG) of Extended Ultraviolet (EUV) radiation, and high power ultra fast lasers for non-thermal ablation of materials, two-photon fluorescence, four-wave mixing spectroscopy, as well as two photon lithography.

Waveguide lasers, such as fiber lasers and semiconductor lasers, are known to be efficient and capable of generating a high output power. However, the output power is limited by thermal considerations and induced facet damage at high output power density. To increase brightness and control the mode quality, the semiconductor laser beam can be focused into an optical fiber having a small etendue (i.e. small product of core diameter and numerical aperture of the fiber). In another approach, a plurality of semiconductor or fiber optic gain elements, a lens, a wavelength dispersive element, and a partially reflecting element can be arranged in an external cavity and generate a high-power overlapping or coaxial beam.

Short laser pulses with high peak power can be produced, for example, by Q-switching or by mode-locking. A particularly useful passive mode locker is an intracavity semiconductor saturable absorber mirror (SESAM). SESAM's have been successfully used for mode-locking individual semiconductor diode lasers, with the SESAM's placed directly on the individual lasing elements. However, this approach has a limited optical peak power, because care has to be taken that the pulse energy does not cause catastrophic facet damage. The design of saturable absorbers can be optimized for either Q-switching or mode-locking, for example, by tailoring the recovery time to the cavity design and having a pulse energy that is 3-5 times the saturation fluence. The incident pulse energy on the saturable absorber can be adjusted by the incident mode area, i.e. how strongly the cavity mode is focused on the saturable absorber.

It would therefore be desirable to overcome the peak power limitations caused by facet-loading in mode-locked fiber and diode lasers and to provide an inexpensive fiber or semiconductor lasing device that can generate short optical pulses with a high peak power.

### SUMMARY OF THE INVENTION

The described device and method are directed, inter alia, to a fiber or semiconductor laser source that can generate short (picosecond or femtosecond) pulses with high peak power, and more particularly to a laser system with multiple gain elements that are mode-locked together with a common mode-locking device, such as a semiconductor saturable absorber mirror (SESAM).

According to one aspect of the invention, a device for producing a mode-locked optical output beam includes a plurality of gain elements, at least one diffracting element that combines the optical beam emitted by the gain elements to form an overlapping output beam; and a mode-locking device, that intercepts the overlapping output beam and in cooperation with the end mirrors forms the external cavity. The mode-locking device commonly mode-locks the gain elements emitting the optical beams, thereby forming a mode-locked optical output beam.

With this approach, the average output is increased by operating several gain elements, such as semiconductor waveguides or optical fibers, in parallel and subsequently combining their output beams to generate an overlapping or coaxial output beam with an optical pulse energy that is essentially equal to the sum of the optical pulse energies of the output beams of the individual lasers. Furthermore, if the electric fields of the individual laser beams are added in phase the instantaneous power may increase as the square of the sum of the electric fields.

In one advantageous embodiment, gain elements can include optical waveguides, such as optical fibers, which can be doped with Ytterbium and/or Erbium, microlasers and semiconductor waveguides. The semiconductor waveguides can include waveguide structures, including quantum wells, selected from III-V and II-VI semiconductors and mixtures thereof, such as GaAs—GaAlAs, GaInAsN, GaInAsP, ZnSeS, CdSeS, and the like. mode-locking device such as a semiconductor saturable absorber mirror (SESAM),

The device can also include a phase-measuring device intercepting a portion of the mode-locked output beam and determining a phase characteristic of the mode-locked output beam. The phase-measuring device can be fabricated from, for example, a frequency-resolved optical gating (FROG) device. The phase-measuring device can simultaneously measure the phase relationship between most or all the gain elements based on the phase characteristic of the overlapping pulsed output beam. The signal measured by the phase-measuring device is analyzed and supplied to a phase adjuster disposed in the common laser cavity. The phase adjuster can separately adjust the optical path length of the laser elements in response to the determined phase characteristic so as to thereby phase-lock all the modes.

The phase adjuster can adjust the geometric length and/or the refractive index of an optical element disposed in the optical path. For example, the optical path can be adjusted by placing an intra-cavity prism, a liquid crystal and/or chirped dielectric mirror in the cavity. In semiconductor gain media, the refractive index can be adjusted by injecting carriers into, for example, an unpumped region of the semiconductor laser elements.

A non-linear optical medium, such as a glass plate, can be place inside the external cavity to broaden the emission frequency bandwidth of the gain elements. This can close any gaps in the emission spectrum. Alternatively or in addition, beam deflectors can be placed so as to intercept the individual beams emitted from the gain elements. The beam deflectors can change the angle of incidence of the individual optical beams onto the diffracting element, thereby changing an emission frequency or emission frequency range of the gain elements.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a commonly mode-locked external cavity semiconductor laser array with a SESAM and a phase controller;

FIG. 2 shows pulse stretching/compression achieved with a diffractive element;

FIG. 3 shows schematically spectral broadening achieved with a non-linear medium; and

FIG. 4 shows schematically beam steering with MEMS mirrors for wavelength tuning.

### DETAILED DESCRIPTION OF CERTAIN ILLUSTRATED EMBODIMENTS

The system described herein is directed to arrays of gain elements, such as optical fibers, laser crystals, e.g. microlasers, and semiconductor lasers that are mode-locked in common in an external cavity and generate short optical pulses of high peak intensity. In particular, the system described herein uses phase matching between the cavity modes of different gain elements.

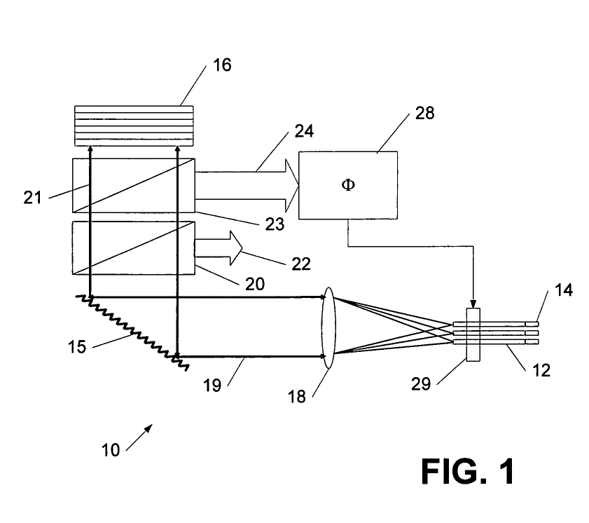

FIG. 1 shows schematically an exemplary mode-locked external cavity laser system 10 with an array of gain elements 12. In the depicted embodiment, the external cavity is formed by end mirrors 14 and a common semiconductor saturable absorber mirror (SESAM) 16 operating as a mode-locking device. Disposed inside the cavity is also a diffractive element (grating) 15 that diffracts the lasers beams 19 emitted by lasers 12 after collimation by a lens 18. Although the collimated laser beams 19 are shown in FIG. 1 as a single beam, the different collimated beams emitted by the different gain elements 12 will actually be at a slight angle with respect to one another. The diffracted beam 21 is preferably a collinear overlapping beam 21 formed from and having the spectral contents of all the individual laser beams 19. The overlapping beam 21 is reflected by SESAM 16 and diffracted on its return path by the grating 15, with the separated spectral contents of beam 21 completing its round trip to the semiconductor laser elements 12. The depicted SESAM is only one example of a mode-locking device, and other types of mode-locking devices, such as Pockels cells, can also be employed.

A portion of the overlapping beam 21 can be extracted by a first beam splitter or partially reflective mirror 20 to form an overlapping output beam 22. Another portion of the overlapping beam 21 can be extracted by a second beam splitter or partially reflective mirror 23 to form an overlapping output beam 24. Output beam 24 is received by a phase measuring system 28 that measures the relative phases of the spectral lines associated with the various lasers 12. Since the lasers 12 tend to operate independently, they are typically not spatially phase-coherent. Adjusting the phase, i.e. round trip travel trip, of the light emerging from each laser is critical for mode-locking.

The relative phase of each laser element 12 can be adjusted by inserting in the corresponding optical path an externally adjustable phase-shifter 29. Phase shifters operate, for example, by changing the optical length n·1 in an optical path, wherein n is the refractive index of the material forming the optical path and 1 is the length of the optical path. The optical length can be changed by adjusting either n or 1. This may be achieved by passive or active means. For example, if the optical path is represented by a semiconductor waveguide, a suitable adjustment of the optical path length may be made by individual waveguide sections by injecting carriers in the individual semiconductor waveguides which alter the refractive indices of each section. Alternatively or in addition, round trip compensation can be achieved by intra-cavity prism pairs, or other means of intra-cavity round trip compensation sections, such as liquid crystal arrays or chirped dielectric mirrors. Phase adjustments can therefore be easily performed.

An exemplary phase measurement system known in the art that can be used for measuring spectrograms (frequency-time domain plots) is referred to as FROG (Frequency-Resolved Optical Gate). FROG is an autocorrelation-type measurement in which the autocorrelator signal beam is spectrally resolved. Instead of measuring the autocorrelator signal energy vs. delay directly, which yields an autocorrelation, FROG involves measuring the signal spectrum vs. delay. Other phase-measurement systems known in the art can be used instead of FROG. The phase of each laser can hereby be monitored and feedback can be provided to the system to adjust the phase of the light from each laser. Such correction is possible in real time.

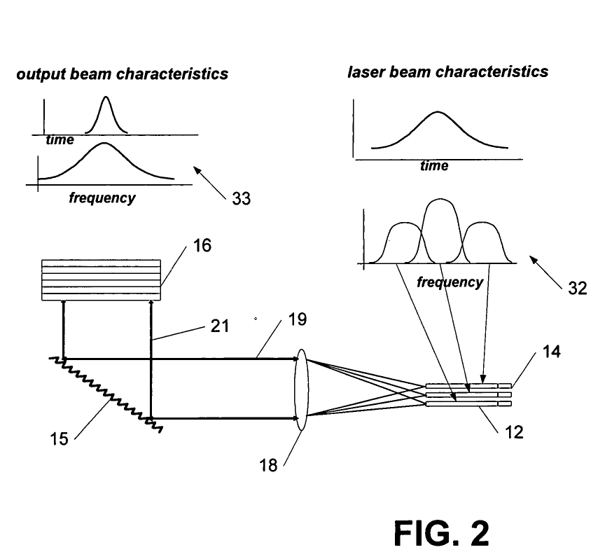

As seen in FIG. 2, all of the individual laser cavities are formed of one end mirror 14 of a gain element 12 and a common shared end mirror 16 (SESAM). The cavity end mirrors 12, 16 provide nodes in the oscillating fields of each mode and therefore also provide spatial phase correlation. The simultaneous opening of all the cavities by the SESAM ensures temporal overlap of the lasing modes. However, the temporal overlap may deteriorate, e.g., if independent reentrant lengths change due to thermal fluctuations in the gain media. In this case, the pulse from a laser with a mistimed lasing path can arrive when the SESAM is closing, or has not yet opened, thus suppressing feedback for that laser. Since the gain in the media builds up exponentially, the energy output from the mistimed laser will be reduced significantly, and the mistimed laser can be identified, for example, from an intensity dip in the frequency band associated with that laser, rather than, as discussed above, from a phase mismatch, which is the traditional method of measuring a phase mismatch between independently operating lasers. Stable operation can be achieved by changing the cavity path lengths through active feedback, as described above.

The energy achievable with the proposed system will depend on the number of gain elements that can simultaneously operate.

The high peak output power is achievable not only through combination of a large number of laser elements 12, but also because the diffractive element 16 alters the relative temporal characteristic of the pulsed beams 19 and 21. This is shown in FIG. 2. As a result, the peak power on the facets is reduced (see inset 32) while the overlapping beam 21, which has a higher peak power (see inset 33) is spread over a large area of the SESAM 16.

As also seen in FIG. 2, the mode-locked output pulse incident on SESAM 16 has a temporal characteristic shown in inset 33 with an effective pulse duration Δτₛ=2/Δvₛ, wherein Δvₛ is the frequency bandwidth of the pulse. The beams after diffraction (inset 32) have a narrower bandwidth Δv_{diff} than the bandwidth Δvₛ of the original seed beam, with the narrower bandwidth corresponding to the fraction

$$F = \frac{Δ {v}_{diff}}{Δ {v}_{s}}$$

of the oscillating bandwidth Δvₛ that is captured by each gain element 22. For example, if F has a value of 300, then a mode-locked output pulse having a width of 100 fs would produce a stretched seed pulse with a duration of 300·100 fs or 30 ps at each laser element facet. The narrower bandwidth hence translates into a greater pulse width Δτ_{diff}, as indicated in the inset 32. The limit of energy extraction for a 100 fs pulse having an energy of 0.5 pJ can thereby be increased to 300×0.5=150 pJ. The pulse are added at the output to 300×150=45,000 pJ or 45 nJ. Thus the total energy gain/pulse in this geometry is 9×10⁴.

The SESAM 16 should preferably have a spectral reflectivity range that encompasses the overall wavelength range of the laser elements 12 to be included in the output beam 21. A tunability range of 50 nm has been reported for AlAs—AlGaAs multi quantum well (MQW) Bragg mirrors used with a diode-pumped Cr:LiSAF laser. A stop band (bandwidth) of greater than 100 nm has been reported for GaAs—AlGaAs distributed Bragg reflectors used with a Yb-doped fiber laser. A SESAM with a GaInNAs-based absorber has also been reported. SESAM's of this type would be suitable for the present application.

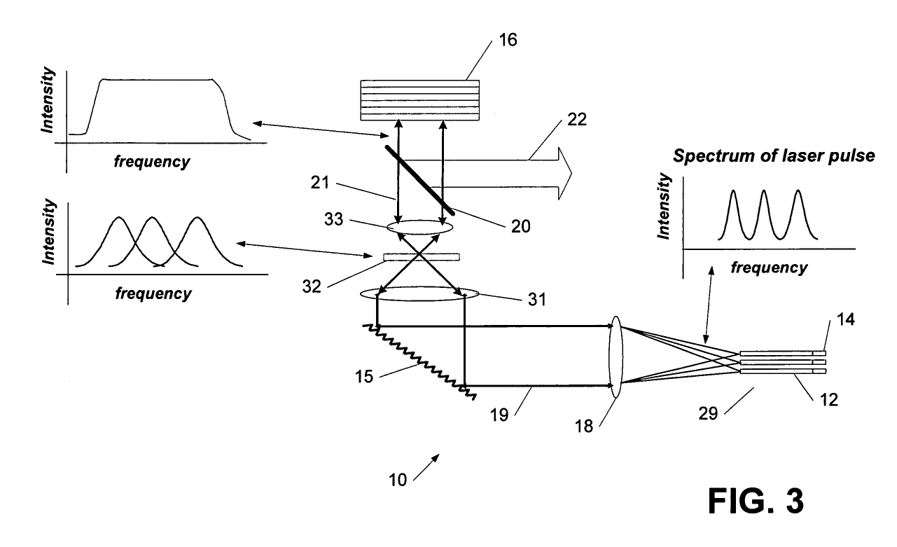

In the exemplary multi-element laser system 10 of FIG. 1, the full optical bandwidth is determined by the placement of the gain strips relative to the dispersion of the grating and the gain bandwidth of the laser media. Thus, the entire gain bandwidth of the medium may not participate in laser action, which may result in a short sequence of femtosecond pulses. This deficiency can be remedied by placing a non-linear optical medium, such as a glass plate, inside the laser cavity to fill in the spectral gaps in the sampled spectrum by the process of Self Phase Modulation (SPM). This approach is also illustrated in FIG. 3, with the insets showing the spectral broadening effect. The exemplary spectrum emitted by the laser elements 12 exhibits three distinct peaks separated by gaps. A glass plate 32 is placed between two collimating lenses 31, 33 in the beam path 21. The phase adjuster 28 and the mirror 21 shown in FIG. 1 have been omitted from FIG. 3 for sake of clarity. The glass plate 32 broadens the spectral width of each peak, thus filling in the gaps between the peaks. The beam 21 incident on the SESAM 16 then has a broad spectral width with substantially uniform intensity. This rather broad spectral range of the combined spectrum also translates into a very short (picosecond or femtosecond) mode-locked pulse, as discussed above.

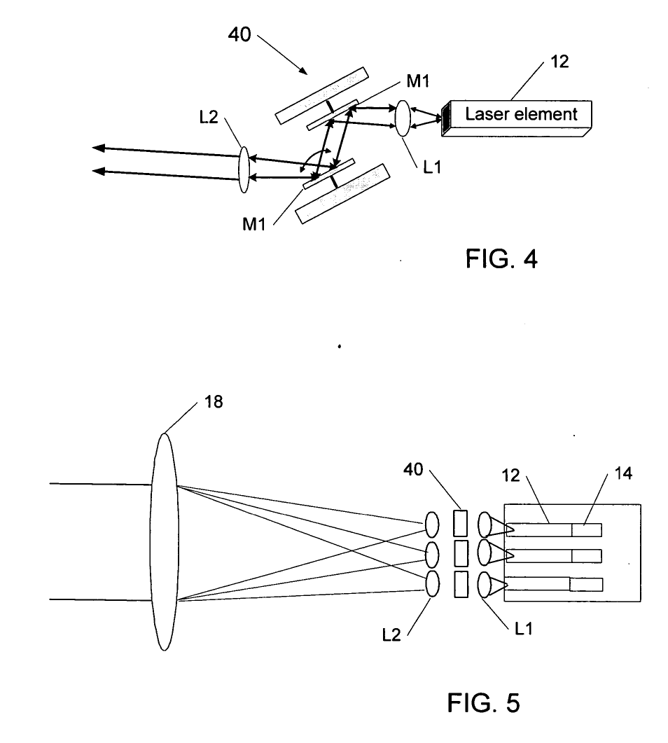

In many applications, such as nonlinear spectroscopy, it may be desirable to be able to shift the spectral output from the individual emitters 12 rather than to fill gaps in the spectrum. As shown schematically in FIG. 4, the small beam emitted by one of the laser elements 12 is incident on a MEMS mirror assembly 40 having a mirror pair M1, M2. MEMS mirror assembly 40 can be produced, for example, on Si substrates and deflect the light beam through microscopic changes in the MEMS mirror position/orientation. The combined movement of the first mirror M1 and the second mirror M2 can cause a lateral offset of the beam exiting lens L2.

FIG. 5 shows schematically a location for placement of the MEMS mirror assembly 40 in the optical cavity. The optical elements of the optical cavity that are not required for an understanding of the operation of the MEMS mirror 40, such as the grating 15, mirror 20 and SESAM 16 have been omitted for sake of clarity. Moving the MEMS mirror will change the incident angle onto the grating, thus shifting the tuned mode-locked wavelength from each laser element 12.

The optical power emitted by the various laser elements 12 can be adjusted and optionally equalized by positioning attenuators in the optical path of each laser element 12. Although not explicitly shown in a drawing, for example, the MEMS assembly 40 of FIG. 5 could be replaced with attenuator elements, or the attenuator elements could be added to the MEMS assembly 40. Alternatively, the electric pump current of each semiconductor laser 12 or the optical pump power to each solid state/fiber gain element may be adjusted to produce a uniform optical output power across the spectral range of beam 21.

The MEMS assembly 40 of FIG. 5 could also be replaced with elements that adjust the optical path, or the elements that adjust the optical path could be added to the MEMS assembly 40, such as the aforedescribed intra-cavity prism, liquid crystal and/or chirped dielectric mirror.

While the invention has been disclosed in connection with the preferred embodiments shown and described in detail, various modifications and improvements thereon will become readily apparent to those skilled in the art. For example, instead of using optical fibers as a gain medium, a gain medium may be fabricated on a planar surface as an array of optical waveguides, as is done in the fabrication of semiconductor waveguide amplifiers for communications systems. This fabrication method alleviates the requirement of handling multiple fibers. Accordingly, the spirit and scope of the present invention is to be limited only by the following claims.

What is claimed is:

1. A mode-locked external cavity laser device, comprising:
a plurality of gain elements, each having an end mirror and a corresponding gain curve;
a diffracting element that diffracts optical beams emitted by the gain elements and combines the diffracted optical beams to form an overlapping output beam; and
a mode-locking device that intercepts the overlapping output beam and in cooperation with the end mirrors forms the external cavity, said mode-locking device operative so as to commonly mode-lock the gain elements emitting the optical beams, thereby forming a mode-locked optical output beam.

2. The device of claim 1, wherein the gain elements comprise an optical waveguide.

3. The device of claim 2, wherein the optical waveguide comprises a semiconductor waveguide.

4. The device of claim 3, wherein the semiconductor waveguide comprises a waveguide selected from III-V and II-VI semiconductors and mixtures thereof.

5. The device of claim 2, wherein the optical waveguide comprises an optical fiber waveguide.

6. The device of claim 5, where the optical fiber waveguide comprises a dopant selected from Ytterbium and Erbium.

7. The device of claim 1, where the mode-locking device comprises a semiconductor saturable absorber mirror (SESAM).

8. The device of claim 1, further comprising
a phase-measuring device intercepting a portion of the mode-locked output beam and determining a phase characteristic of the mode-locked output beam; and
a phase adjuster configured to separately adjust an optical path length of the laser elements in response to the determined phase characteristic.

9. The device of claim 8, wherein the phase adjuster adjusts at least one of a geometric length and a refractive index of an optical element disposed in the optical path.

10. The device of claim 9, wherein the refractive index is adjusted by injecting carriers into at least a region of the laser elements.

11. The device of claim 9, wherein the geometrical path is adjusted by an element selected from the group of intra-cavity prism, liquid crystal and chirped dielectric mirror.

12. The device of claim 8, wherein the phase-measuring device comprises a frequency-resolved optical gating (FROG) device.

13. The device of claim 8, wherein the phase-measuring device measures simultaneously a phase relationship between a plurality of the gain elements based on the phase characteristic of the overlapping pulsed output beam.

14. The device of claim 1, further comprising a non-linear optical medium disposed in the cavity to broaden an emission frequency bandwidth of the gain elements.

15. The device of claim 14, wherein the non-linear optical medium comprises a glass plate.

16. The device of claim 1, further comprising beam deflectors associated with corresponding ones of the gain elements, said beam deflectors changing an angle of incidence of the optical beams emitted by the gain elements onto the diffracting element, thereby changing an emission frequency or emission frequency range of the gain elements.

17. The device of claim 16, wherein the beam deflectors comprise micromachined mirrors.

18. The device of claim 16, wherein the beam deflectors comprise a pair of actuated micromachined mirrors.
